(19) United States
(12) Patent Application Publication
(10) Pub. No.: US 2012/0103971 A1
(43) Pub. Date: May 3, 2012

(54) COOKING APPLIANCE AND A CONTROL METHOD THEREOF

(75) Inventors: Doo Yong Oh, Seoul (KR); Byeong Wook Park, Seoul (KR)

(73) Assignee: LG ELECTRONICS INC., Seoul (KR)

(21) Appl. No.: 13/266,650

(22) PCT Filed: Sep. 9, 2009
(86) PCT No.: PCT/KR2009/005115

§ 371 Date: Jan. 9, 2012

(30) Foreign Application Priority Data
May 4, 2009 (KR) 10-2009-0038997

(51) Int. Cl. H05B 3/76

(52) U.S. Cl. 219/465.1

(57) ABSTRACT

Provided are a cooking appliance and a control method thereof. A cooking appliance according to an embodiment of the present invention comprises a top plate on which a cooking container is placed, a plurality of winding parts including a plurality of coils horizontally arranged under the top plate, a plurality of relay parts including a plurality of relays that each connected to the plurality of coils, and an inverter part for applying a voltage of high frequency to the plurality of winding parts.

### TECHNICAL FIELD

The present invention relates to a cooking appliance, and more particularly, to a cooking appliance capable of heating all locations that a cooking container is placed on the cooking appliance.

### BACKGROUND ART

In general, a cooking appliance is a device for cooking by heating food using gases or electricity. The cooking appliance may be separated as an oven, a cooktop, a gas range, and the like. Among them, the cooktop is a appliance for heating and cooking food according to a radiant heating or an induction heating way by using electricity mainly.

The inductive heating way is a method heating a cooking container which is a metal body using electromagnetic induction, wherein when a current is supplied to the coil, an eddy current is generated into the cooking container to be heated and a temperature is increased by line heating generated by the resistance of the metal.

The cooktop of the induction heating way is usually composed of two to five burners and one burner consists of one resonant circuit and one Half-bridge inverter. The inverter is a device that produces several tens of kHz high voltage frequency and the resonant circuit is a device that converts energy to heat the container. The Half-bridge inverter consists of two insulated gate bipolar transistor (IGBT), a snubber capacitor and a bridge diode. The resonant circuit consists of a coil and a resonant capacitor. The coil and the resonant capacitor are connected in series.

A cook zone on which the cooking container is placed, is indicated on the top plate of the cooktop and a user cooks by placing the cooking container on a predetermined location. However, it is uncomfortable that the cooking container of various sizes is put on the cook zone in accordance with the corresponding size. In addition, there is a problem that a large cooking container or a square-shaped cooking container is difficult to heat evenly.

### DISCLOSURE

### Technical Problem

In one aspect, the present invention provides a cooking appliance capable of heating all parts of a top plate.

In another aspect, the present invention provides a cooking appliance capable of sensing and heating all locations where the a cooking container is placed.

In yet another aspect, the present invention provides a cooking appliance having an inverter structure for driving a plurality of coils

The aspects of the present invention are not limited to the above-mentioned aspects and further aspects, not described above, will be clearly understood from the description described below by those skilled in the art from.

### Technical Solution

In order to achieve the aforementioned aspects, a cooking appliance according to an embodiment of the present invention including: a top plate on which a cooking container is placed, a plurality of winding parts including a plurality of coils horizontally arranged under the top plate, a plurality of relay parts including a plurality of relays that is each connected to the plurality of coils, and an inverter part for applying a voltage of high frequency to the plurality of winding parts.

In addition, a cooking appliance control method according the embodiment of the present invention, comprising: sequentially operating a plurality of relay parts that is each connected to a plurality of coils horizontally arranged under a top plate on which a cooking container is placed; determining whether the cooking container is placed on any coil of the plurality of coils through the amount of load current generated when the plurality of relays are sequentially operated; and applying a voltage of high frequency to coil on which the cooking container is placed.

Specific items of other embodiments are included in the detailed description and drawings of the present invention.

### Advantageous Effects

According to the cooking appliance and the control method thereof of the present invention, the present invention has the following effects one or more.

Firstly, there is an advantage that all locations where the cooking container is placed on the top plate of the cooking appliance can be heated.

Secondly, there is an advantage that the cooking appliance can be heated evenly regardless of the appearance of the cooking container.

Thirdly, there is an advantage that the cooking container can be heated regardless of the number of burners

Fourthly, there is an advantage that the cost can be reduced without a plurality of inverters.

The effects of the present invention are not limited to the above-mentioned effects and further effects not described above will be clearly understood by those skilled in the art.

### DESCRIPTION OF DRAWINGS

FIG. 1 is a perspective view illustrating a cooking appliance according to the first embodiment of the present invention;

FIG. 2 is a perspective view showing an upper palate in the cooking appliance shown in

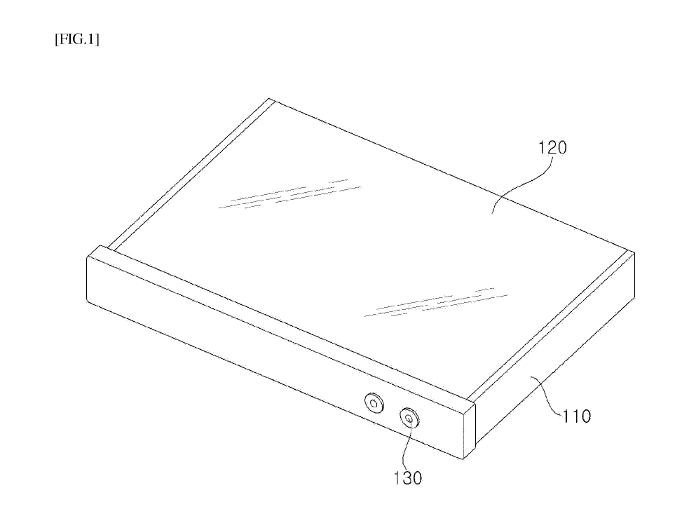

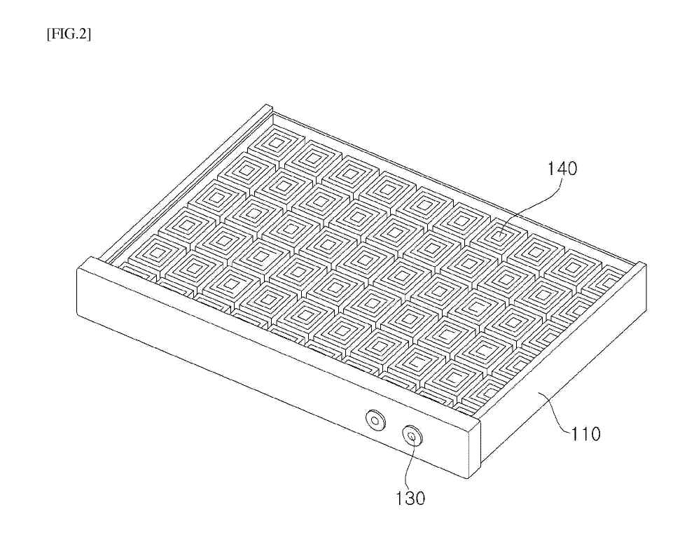

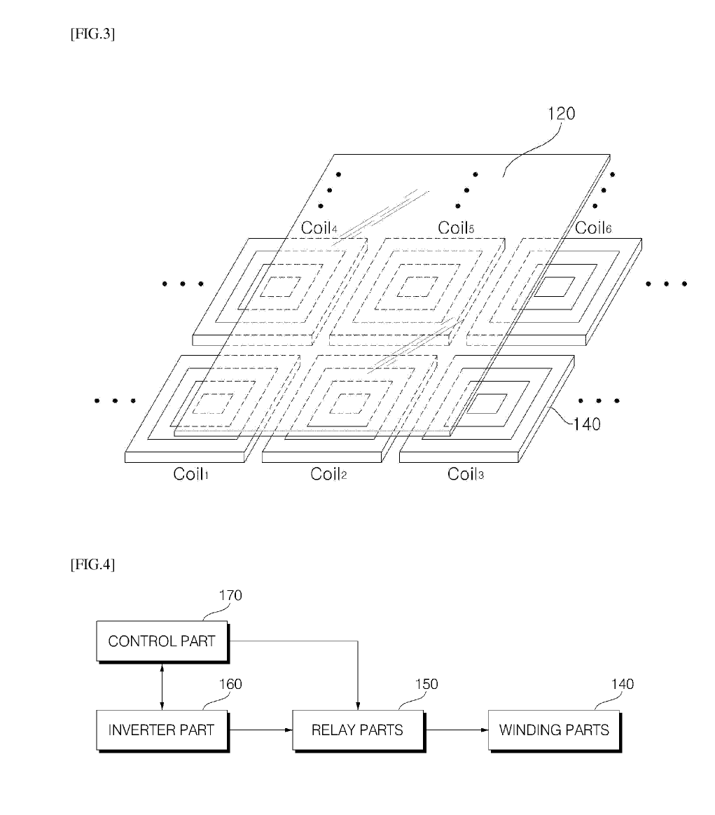

FIG. 1;

FIG. 3 is a partial perspective view showing the cooking appliance shown in FIG. 1;

FIG. 4 is a block diagram illustrating a cooking appliance according to the first embodiment of the present invention;

FIG. 5 is a partial circuit diagram illustrating the cooking appliance shown in FIG. 4; and

FIG. 6 is a flow chart illustrating a cooking appliance control method according to a first embodiment of the present invention.

### BEST MODE

Advantages and features of the present invention, and method to achieve them of the present invention will be obvious with reference to embodiments along with the accompanying drawings which are described below. Meanwhile, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims. In the detailed description, the same reference numbers of the drawings refer to the same or equivalent parts of the present invention.

Hereinafter, a cooking appliance and a control method thereof of the present invention will be described with reference to the drawings through embodiments of the present invention.

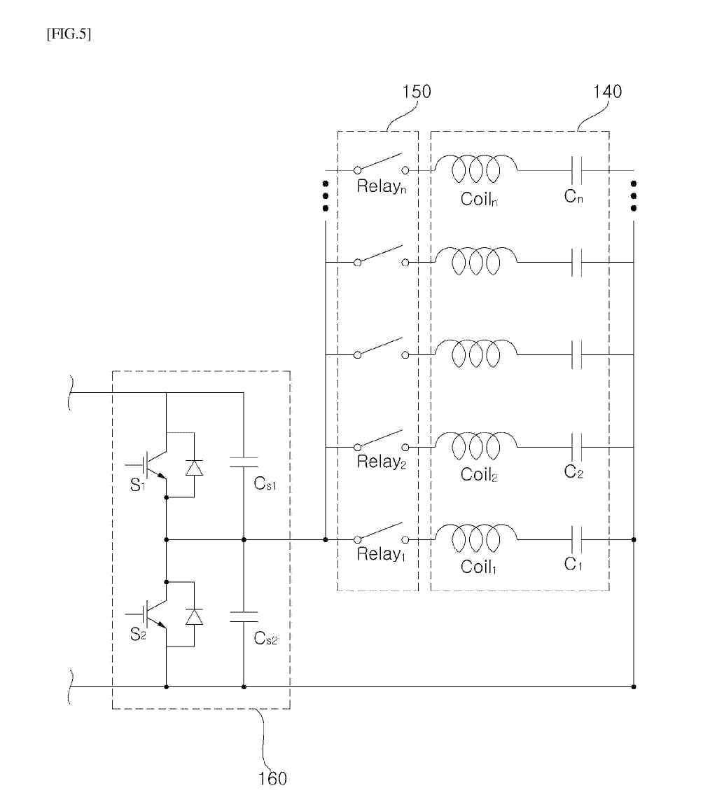

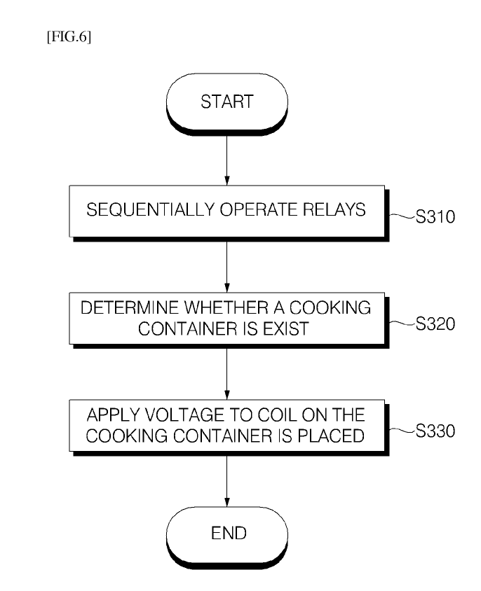

FIG. 1 is a perspective view illustrating a cooking appliance according to the first embodiment of the present invention; and FIG. 2 is a perspective view in which an upper plate is removed from the cooking appliance of FIG. 1. FIG. 3 is a partial perspective view showing the cooking appliance shown FIG. 1.

According to the first embodiment of the present invention, the cooking appliance includes a main body 110 forming the appearance, a top plate 120 on which a cooking container is placed, an operation part 130 for operation of the user and a plurality of winding parts 140 heating the cooking container.

The main body 110 forms the appearance of the cooking appliance and the top is covered by the top plate 120. The top plate 120 supports the cooking container and is preferably formed by glass-ceramic in case of a cooktop.

A plurality of winding parts including a plurality of coils Coil1, Coi12, . . . , Coiln are provided under the top plate 120. The plurality of coils are horizontally arranged under the top plate 120. Preferably, the each coil is formed as rectangular shape and arranged to cover the bottom of the top plate, like a tile.

FIG. 4 is a block diagram of a cooking appliance according to the first embodiment of the present invention; and FIG. 5 is a partial circuit diagram of the cooking appliance of FIG. 4.

According to the first embodiment of the present invention, the cooking appliance includes a plurality of winding parts 140 including a plurality of coils, a plurality of relay parts 150 connected to the plurality of winding parts, and an inverter part for applying a voltage of high frequency to the plurality of winding parts, and a control part 170 which controls operations.

The plurality of winding parts 140 includes a plurality of coils Coil1, Coi12, . . . , Coiln as described above. Preferably, the each coil is connected with the inverter part 160 in parallel. The plurality of winding parts 140 includes a plurality of capacitors C1, C2, . . . , Cn each connected to the plurality of coils.

The plurality of relay parts 150 includes a plurality of relays (Relay1, Relay2, . . . , Relayn) each connected to the plurality of coils Coil1, Coi12, . . . , Coiln. The each relay controls each coil connected in series and can control a duty. That is, when the relay is operated, high frequency voltage is applied to coil connected to the relay and the duty can be controlled.

The inverter part 160 applies the high frequency voltage to the plurality of winding parts 140. Preferably, the inverter part 160 includes two IGBT S1, S2 and two snubber capacitors Cs1, Cs2. Further, the inverter part 160 is preferably connected with the plurality of coils Coil1, Coi12, . . . , Coiln in parallel. The inverter part 160 supplies frequencies in accordance with an output that the user wants. The inverter part 160 may include a plurality of inverter parts in accordance with a maximum output required for each of products.

The control part 170 sequentially operates the plurality of relays Relay1, Relay2, . . . , Relayn and supplies detection frequencies. The control part 170 determines whether the cooking container is placed on any coil of the plurality of coils Coil1, Coi12, . . . , Coiln through the amount of load current generated when the plurality of relays are sequentially operated.

The control part 170 operates a relay of the coil on which the cooking container is placed when cooking and supplies high frequency voltage to the corresponding coil. The inverter part 170 adjusts frequencies in accordance with an output that the user wants. When several containers are placed and different outputs must be produced, the frequency of the inverter part 160 is fixed and controls the duty of the relay.

FIG. 6 is a flow chart illustrating a cooking appliance control method according to a first embodiment of the present invention.

The plurality of relays Relay1, Relay2, . . . , Relayn which is each connected to the plurality of coils Coil1, Coi12, . . . , Coiln horizontally arranged under the top plate 120 on which the cooking container is placed, are sequentially operated (S310). When the user places the cooking container on any one of all locations of the top plate 120 and operates the cooking appliance through the operation part 130, the control part 170 sequentially operates the plurality of relays Relay1, Relay2, . . . , Relayn to determines a location on which the a cooking container is placed. When the control part 170 sequentially operates the plurality of relays, detection frequencies are supplied and the amount of the load current is measured.

The control part 170 determines any coil of the plurality of coils Coil1, Coi12, . . . , Coiln on which the cooking container is placed through the amount of load current generated when the plurality of relays Relay1, Relay2, . . . , Relayn are sequentially operated (S320). When the cooking container is placed on the coil, since the amount of the load current is varied, the control part 170 can determine whether the cooking container is placed on the corresponding coil (S320).

A high frequency voltage is applied to the coil on which the cooking container is placed. The control part 170 operates a relay of the coil on which the cooking container is placed when cooking and supplies the high frequency voltage to the corresponding coil. The inverter part 170 adjusts frequencies in accordance with an output that the user wants. When several containers are placed and different outputs must be produced, the frequency of the inverter part 160 is fixed and controls a duty of the relay.

Those skilled in the art will understand that the present invention can be implemented as other concrete forms without changing the inventive concept or essential features. Therefore, these embodiments as described above are only proposed for illustrative purposes and do not limit the present invention. It will be apparent to those skilled in the art that a variety of modifications and variations may be made without departing the spirit and scope of the present invention as defined by the appended claims. Further, such modifications and variations should not be understood independently from the technical idea or perspective of the present invention.

1. A cooking appliance comprising:
a top plate on which a cooking container is placed;
a plurality of winding parts including a plurality of coils horizontally arranged under the top plate;
a plurality of relay parts including a plurality of relays that is each connected to the plurality of coils; and
an inverter part for applying a high frequency voltage to the plurality of winding parts.

2. The cooking appliance of claim 1, wherein the plurality of coils are connected to the inverter part in parallel.

3. The cooking appliance of claim 1, wherein the plurality of winding parts include a plurality of capacitors each connected to the plurality of coils.

4. The cooking appliance of claim 1, wherein the coils are rectangular, and the plurality of coils are arranged to cover the bottom of the top plate, like a tile.

5. The cooking appliance of claim 1, further comprising:
a control part for sequentially operating the plurality of relays.

6. The cooking appliance of claim 5, wherein the control part determines whether the cooking container is placed on any coil of the plurality of coils through the amount of load current generated when the plurality of relays are sequentially operated.

7. The cooking appliance of claim 5, wherein the control part adjusts an output by controlling a duty through the relay.

8. A cooking appliance control method, comprising:
sequentially operating a plurality of relay parts that is each connected to a plurality of coils horizontally arranged under a top plate on which a cooking container is placed;
determining whether the cooking container is placed on any coil of the plurality of coils through the amount of load current generated when the plurality of relays are sequentially operated; and
applying a high frequency voltage to coil on which the cooking container is placed.

9. The cooking appliance control method of claim 8, further comprising :
adjusting an output by determining a duty through the relay.
